(19) United States
(12) Patent Application Publication
(10) Pub. No.: US 2019/0360907 A1
(43) Pub. Date: Nov. 28, 2019

(54) MULTIMODAL SYSTEM FOR ESTIMATING THE VOLUME AND DENSITY OF A BODY

(71) Applicant: Facultad de Ingenieria - Universidad Nacional de Asuncion, Ciudad San Lorenzo (PY)

(72) Inventors: Fernando Javier BRUNETTI FERNANDEZ, Asuncion (PY); Ricardo Matias LOREIRO QUEVEDO, San Lorenzo (PY); Sergio Manuel BRITEZ VALENZUELA, San Lorenzo (PY); Eduardo Daniel REDONDO RUIZ DIAZ, Asuncion (PY)

(21) Appl. No.: 16/030,146

(22) Filed: Jul. 9, 2018

(30) Foreign Application Priority Data
May 25, 2018 (PY) P 1839496

(51) Int. Cl. G01N 9/02

(52) U.S. Cl. CPC G01N 9/02; G01N 2009/024

(57) ABSTRACT

The present invention consists of a system for estimating the volume and density of a body by using multiple sensors and technologies. The system comprises a control unit in charge of driving, controlling, synchronizing, acquiring, processing, displaying and communicating with the other modules of the system; a platform for measuring the weight of the user, such as a personal scale or balance; at least a pair of sensor array control units; a sensor array connected to each controller and which in turn is made up of capacitive sensors and optical sensors, and a mobile unit or device. The system allows the volume of the body to be estimated by areas, as well as an estimation of the general density, in a simple and non-obtrusive way. The information of the volume, weight and density of the user is displayable in a mobile unit and stored in remote servers, which allows the user to monitor the evolution of these physiological variables.

### CROSS REFERENCE TO RELATED APPLICATION

This application claims priority of Paraguay Application No. P 1839496 PY filed May 25, 2018, application which is incorporated herein by reference.

### FIELD OF THE INVENTION

The present invention can be included in the technical field of measurement, in particular of measuring and estimating the volume and density of bodies by multiple complementary means such as optical, capacitive and mechanical means. More specifically, the object of the invention relates to a system for estimating the volume and density of a body without making contact with the same.

More specifically, the present invention relates to a system for estimating the volume and density of a body by means of the use of multiple sensors and technologies, wherein said system comprises a control unit in charge of driving, controlling, synchronizing, acquiring, processing, displaying and communicating with the other modules of the system; a platform for measuring the weight of the user, such as a personal scale or balance; at least a pair of sensor array control units; a sensor array connected to each control unit and which in turn is made up of capacitive sensors and optical sensors; and of a mobile unit. Thus, the system of the present invention allows the volume of the body to be estimated by areas, as well as an estimation of the general density, in a simple and non-obtrusive way, unlike other currently existing systems. The information of volume, weight and density of the user is displayable on a mobile unit and stored in remote servers, which allows the user to monitor the evolution of these physiological variables.

### BACKGROUND OF THE INVENTION

There are currently numerous technologies that help people monitor their daily activity and evolution in a smart and ubiquitous way, meaning in the most passive way possible, without the need for continuous intervention, which are minimally invasive and obtrusive, using systems that access this information and which are able to generate a report and alarms, as well as assist in the monitoring and evolution of these parameters in an orderly and systematic way.

One example of this type of technology is the smart balances or scales for monitoring people's weight. These scales detect and measure physiological parameters such as weight and indicate the body fat index of a user who stands on the platform. Moreover, these data are stored in servers on the Internet, which allows the user to periodically monitor their weight and other physiological variables through an application or service.

In line with the previous example, the weight of a person or their electrical conductance associated with their level of body fat is not the only variable of interest when measuring the morphology and body composition of the user. Other variables that are highly important are the volume and density of the body and the distribution of the same in the different areas of the body.

This being so, in the state of the art there is a plurality of disclosures related to devices or systems for estimating or measuring the body variables of a user, such as document US 20170296097 which defines systems and methods for estimating the volume and density of a specific body, wherein said system and method are based on the detection of a series of tensions, the difference between which allows an estimated volume to be obtained, and which has a computing device that is able to transmit the detected tension to a user device, such that said device can use detected tensions to carry out a series of evaluations. The method and system makes use of the tension of the user's clothes to indicate that a density of a target muscle of a user is greater, less, or substantially consistent with a normal or typical muscle density, and this way estimates the volume of the same.

However, the former is mainly based on the method of the difference in tensions to make an estimation based on the tension on the user's clothes, and therefore the measurement is not totally reliable and can be significantly flawed, since it is not the muscle volume that is considered but rather the way it affects the clothes, which is completely undesirable.

On the other hand, document WO 2016073085 discloses a single chamber volume measurement apparatus, wherein said apparatus is configured to measure the volume of a person, animal, or object, and includes a chamber having a door thereon and defines a fixed volume when the door is closed; an oscillating membrane or diaphragm in a wall of the chamber; a pressure sensor to measure pressure fluctuations in the chamber; and an oscillation amplitude detector coupled to the oscillating membrane or diaphragm. Thus, the chamber generally has a volume sufficient to enclose the person, animal, or object therein, and said volume generally does not vary with relatively small pressure changes or fluctuations.

However, the foregoing has a drawback in that the device or apparatus corresponds to a closed chamber that measures the volume of the object (alive or not) that is located inside the same, and therefore it is necessary to completely close the door to said chamber, which can be very uncomfortable if analysis or estimation of the volume of a living body is required. Likewise, the measurement obtained by using said device is not the most reliable, since it makes use of pressure sensors, and if there is a small leak in the door or in the chamber, the measurement will be completely affected and thus erroneous.

There is also document EP 2784494 which teaches a system for detecting or determining bodies or materials, which has a capacitive sensor with a rigid or flexible insulator formed with a sensor electrode that has an active electrode surface, wherein said sensor electrode is partially integrated in the insulator. The system further comprises a measuring cell that has interior conductive or nonconductive walls that are directed into the interior surface. This way, the sensor is integrated in a recess in the measuring cell wall so that a portion of the active electrode surface of sensor directed into the interior surface of measuring cell wall is replaced.

Just like one of the previously defined documents, the foregoing has the drawback in that it corresponds to a closed element that defines a chamber with closed walls, which could be advantageous for measuring the volume of a fixed body (which is not alive), but for a live body of an animal (human or other) it can be a complicated and a stressful process, a fact which affects the measurement and does not allow a proper volume to be obtained, but rather the same is altered by the condition of the animal in the interior.

Likewise, document CN 201852762 teaches an instrument for measuring the density of wood material, wherein said instrument has a central processing module electrically connected to a volume measuring module; a mass measuring module processes and calculates an input signal by means of the volume measuring module to obtain the density of a wood material, and enters the data into a display element and an input module. The display element and the input module are electrically connected to the central processing module to display the data entering through the central processing module and enter the data into said module. The measuring module comprises three contactless sensors, preferably being laser distance sensors.

However, the density measuring instrument described in the aforementioned document has the drawback in that it does not comprise a plurality of sensors located on the sides of the object with the aim of being able to determine the density or volume of the same in a suitable and precise way, but rather, all of the measuring is done from the lower part, and thus the device cannot be properly used with amorphous articles, such as a living being (human).

Furthermore, in the state of the art we can find document WO 2000025675 which defines a system for measuring the change in volume in at least one portion of a mammal due to respiration, has a current generator to selectively supply alternating current to either a conductive coil or a fixed coil to create an induced voltage in another separate coil. Thus, the system measures the volumes and areas by using electromagnetic induction techniques.

However, this previously defined system is undesirable, since it makes use of electromagnetic induction and coils, and therefore, to generate said electromagnetic energy, a very strong current must be used which can be harmful to human health or cause accidents when being used. Furthermore, this system cannot be used for inert objects, since it makes specific use of the respiration of a living being on the platform with the aim of being able to amplify the signal and through induction take the measurements of volume and area.

Lastly, document JP 7313492 discloses a physical measuring instrument for the human body surface area, wherein for the measurement of volume there is a reflective mirror with an adjustable height that reflects the laser light irradiated such that it indirectly hits the body surface of the person being examined. Thus, an image is formed by means of a camera from the laser light that is reflected off the person being examined. The scanning mirror, reflective mirror and the camera rotate by means of a rotating disc such that all of the peripheries of the body can be photographed and measured. A control module manages the operation of the scanning mirror, the reflective mirror, the camera and the rotating disc, and based on the information obtained, said control module calculates the physical descriptions, such as the body surface area, body volume, circumference of a defined part and height, among others.

According to the information provided in the previous paragraphs, it can be seen that the current solutions for measuring volume generally use scanners based on a type of technology mainly using electromagnetic or optical principles, these devices are often slow, cumbersome and highly sensitive to the environment, making them solutions that are far from ubiquitous, and furthermore invasive and obtrusive, with a big impact on the measuring environment and on the demand of the attention and participation of the user.

Therefore, it may be declared that in the state of the art there is a need to design and implement a device for measuring and/or estimating the volume or area of a specific body, either of a living or lifeless being, wherein it is required that said device take a measurement in an entirely non-invasive way and without using elements that may be harmful to health or which affect the body being measured, wherein furthermore it is necessary that the device allow a completely precise and suitable measurement to be obtained, at the same time, in the case of measuring a living being, the measuring process must not be complicated or stressful.

### DESCRIPTION OF THE INVENTION

In response to the background described, in a modality, the object of the present invention is to provide a device that allows for the estimation of the volume of a body in a non-invasive way and by means of equipment that is practically non-obtrusive.

In another modality, the object of the present invention is to estimate the density of the measured body to thereby be able to complement the previous measurement, with the aim of being able to monitor the evolution of the estimated morphology and body composition.

These objectives and aims are carried out and achieved according to the following invention, by means of methods and a set of sensor apparatuses and elements, processing and control units, communication systems, data acquisition, processing, storage and display systems, which allow for the estimation of the volume of a body and the density thereof by capacitive, optical and mechanical means, and the monitoring of the evolution of these variables over time.

According to the following invention, the estimation of volume is done by a cooperative method based on an optical scanning which allows the height of the body measured to be calculated, a pattern of diffraction and occlusion, caused by the measured body in question, and a capacitance pattern obtained by means of a dynamic array of capacitive sensors.

This being so, the density of the body is obtained in turn by directly relating the volume calculated to the weight measured by means of a scale mounted on the measuring platform in the following way: Estimated density=estimated Weight/Volume

The present thus comprises a control unit in charge of driving, controlling, synchronizing, acquiring, processing, displaying and communicating with the other modules of the system; a platform for measuring the weight of the user, such as a personal scale or balance; at least a pair of sensor array control units; a sensor array connected to each control unit and a mobile unit.

In this sense, the control unit commands the sensor array control units so that the driving of the same is done following the pre-established pattern of scanning by the different sensor elements, both optical and capacitive. Therefore, the sensors are driven in a sequential manner for the purpose of obtaining capacitance patterns and patterns of diffraction and occlusion from the optical sensors that are later used to estimate the volume and density of the user.

Moreover, the control unit also communicates through a wireless interface to remote servers, with the aim of providing the recorded readings of the sensors. It also includes capacities for communicating with a mobile unit, which may be a smart phone or another device developed for such purpose, in order to display the current measurements so that they can be seen by the user.

The platform for measuring the user's weight is connected to the control unit and is controlled by the same. The control unit detects the user's presence, measures their weight and this way, the scan of the other sensors begins to obtain the estimated measurement of the volume and the density. Once the measurement is determined, the information acquired is sent to the mobile unit and the same is stored in the remote servers. Thus, the platform for measuring the weight of the user is based on a conventional digital scale, which is not an object of the present invention in and of itself, but which forms part of the device for which protection is sought.

On the other hand, the sensor array controller communicates with the control unit and once the signal from said control unit is received to take a specific measurement from a sensor element, it controls the acquisition electronics to select and measure the indicated sensor. The measurement order includes the identification of the sensor element, either capacitive or optical, and the configuration of the sensor, for example, able to include a virtual electrode formed by several contiguous cells of the array of capacitive electrodes or of the optical arrangement.

The sensor array control unit is also in charge of controlling the light-emitting elements of the arrangement of optical sensors, which will drive the optical receptors of the sensor array facing the same. Said unit is also in charge of configuring the capacitive electrodes to thus form the capacitive sensor used for the measurement.

On the other hand, the sensor array includes an arrangement of capacitive electrodes laterally limited by two vertical arrangements of photoemitters and photoreceptors, which make up the optical sensors of the system. The electrodes are rectangular metal plates with variable sizes. The distance between the photoreceptors and the photoemitters of a single system is constant, affecting the resolution of the measured patterns of occlusion and diffraction.

By means of the mobile unit or device, the device can be calibrated or configured. Said configuration of the device is understood by the selection of the measuring units used for the measured variables, the definition and selection of users, and the calibration of the device.

The calibration of the device is done by using predefined measuring objects that help establish the parameters of the installation of the device, as well as the use of the variables of the user, such as their height, and other measurements of the body that help improve the initial estimation of the volume and body distribution.

The electric capacitance of the element is a function of the geometry of the arrangement and of the dielectric which makes up the same, wherein at least three elements are clearly identified: a pair of electrodes and the dielectric material. Using precision electronics it is possible to measure the capacitance of an arrangement, wherein said capacitance measured can be correlated with the volume of the dielectric or proportion of shaping between the different dielectrics of the capacitor and the evolution of the same in successive measurements.

The estimation of the volume and density of the user's body is done by relating the capacitance values measured by the capacitive sensor array, the patterns of diffraction and occlusion of the arrangements of the optical sensors and the weight of the person, and then, the estimation information obtained can be directly viewed by the user by means of the mobile unit or device, as was previously stated.

### BRIEF DESCRIPTION OF THE FIGURES

The present invention may be understood more clearly based on the following figures wherein the different components, parts or steps associated with the present device, apparatus, system or method are shown, as well as the novel elements with respect to the state of the art, wherein the figures do not aim to limit the scope of the invention, which is only determined by the attached claims, wherein:

FIG. 1 shows a general view of the system object of the present invention, wherein all of the elements that make up the same are included.

FIG. 2 shows a detailed view of the sensor array and the sensor array control unit of the system of FIG. 1.

FIG. 3 shows a detailed block diagram of the control unit and the sensor array controller.

FIG. 4 shows a block diagram of the system of the present invention.

### DETAILED DESCRIPTION OF THE INVENTION

The previous figures are not shown to scale. The current dimensions of each of the components of the device can vary according to the user's needs. The most significant details of the device are highlighted, with the aim of describing the concepts and functions of the elements that make up the system object of the invention.

The present invention aims to provide a system that allows an estimation of the volume and density of a body to be obtained, wherein said estimation is done in a non-invasive way and with the aim of being able to monitor the evolution of the morphology and body composition estimated, wherein the information is duly controlled and viewed by the user, as can be determined based on the following detailed description of said device.

The system of the present invention comprises the following components and/or parts, wherein the function and interaction of each one of the same is defined below:
A control unit 1 made up of a main controller 14, a wireless interface 15, a memory module 16, a network interface 17, and a battery system 18;
A weight-measuring platform 3;
A mobile device or unit 4;
A main structure 5 for taking measurements and for the placement of the weighted element;
At least one sensor array controller 6 made up of an analog-to-digital converter (ADC) 21, a signal conditioning module 22, a multiplexer 23, a sensor array control unit 24, a driver circuit 25, a battery system 26, and a network interface 27; and
At least one sensor array 8 made up of a plurality of capacitive sensors 9 and a plurality of optical sensors 10.

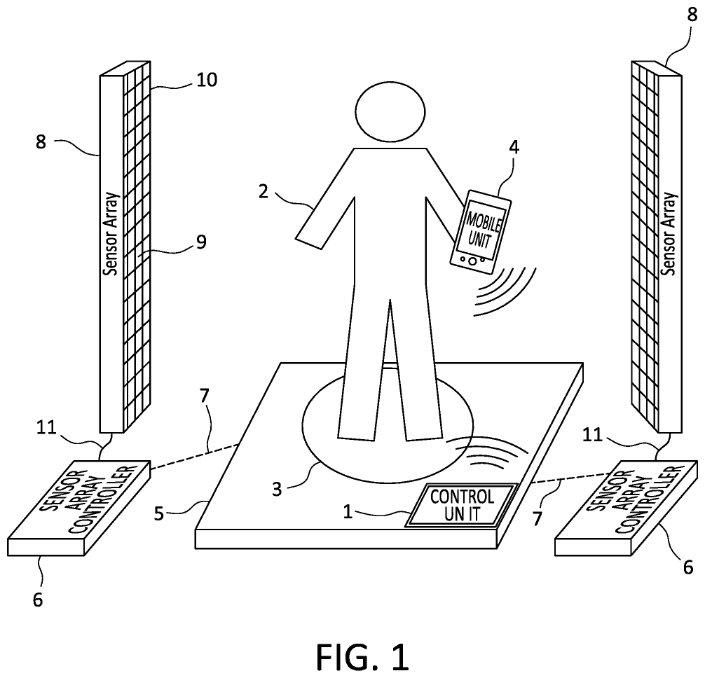

Thus, FIG. 1 shows a general view of the system object of the present invention, in which all of the elements that make up the same are included, wherein the control unit 1, which, as indicated by its name, is in charge of controlling the entire system. Moreover, said control unit 1 also detects the presence of the user 2 when they are on the weight-measuring platform 3 and thus, the information of the volume and density of the user is wirelessly transmitted to the mobile unit or device 4, which displays the data measured and in turn allows the user to configure the system 2. The control unit 1 and the weight-measuring platform 3 are located in the same structure 5, which in turn is connected to the sensor array controllers 6 by means of a connection mechanism, such as cables 7. However, it is important to note that the present invention is not only limited to the wired connection of these elements, but rather it is envisaged that this connection can be wireless without affecting the operation of the system.

The sensor array controller 6, as indicated by the name, controls and acquires the signals of the sensors of the sensor array 8, which is made up of a series of capacitive sensors 9 and at least an arrangement of optical sensors 10, wherein said sensor array 8 is connected by means of a cable 11 to the sensor array controller 6. In the same way as the previously defined connection between the main structure 5 and the sensor array controller 6, the connection between the sensor array 8 and said sensor array controller 6 can be made through cables (through the cable 11) or can be made wirelessly, without affecting the general operation of the system.

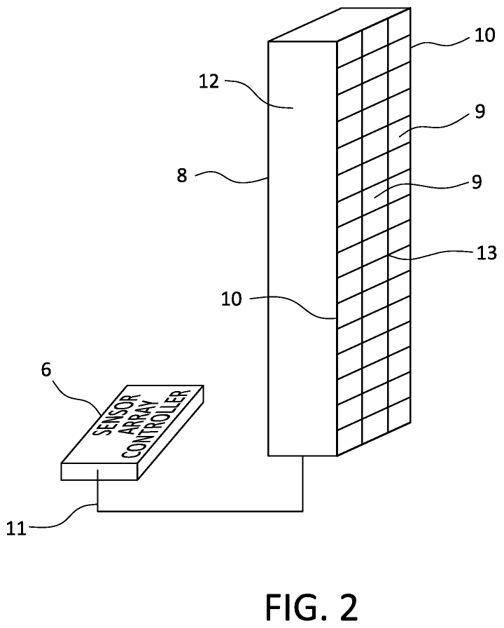

Now, FIG. 2 shows a detailed view of the sensor array 8 and the sensor array controller 6, wherein said sensor array 8 is made up of a series of rectangular electrodes 9 arranged in an array and separated from one another by a space 13, wherein said rectangular electrodes correspond to capacitive sensors 9, previously defined, and wherein said space 13 between electrodes is variable, but preferably is not greater than 2 millimeters. On each side of the sensor array 8, an arrangement of optical sensors 10 is placed, which consists of a row of photoemitters and photoreceptors. All of these sensors, both capacitive and optical 9 and 10 are connected by means of a cable 11 to the sensor array controller 6, but the option of wireless communication between the sensors and the controller 6 is also envisaged, as previously defined. Additionally, the sensor array 8 has a depth 12 that is variable up to a few millimeters.

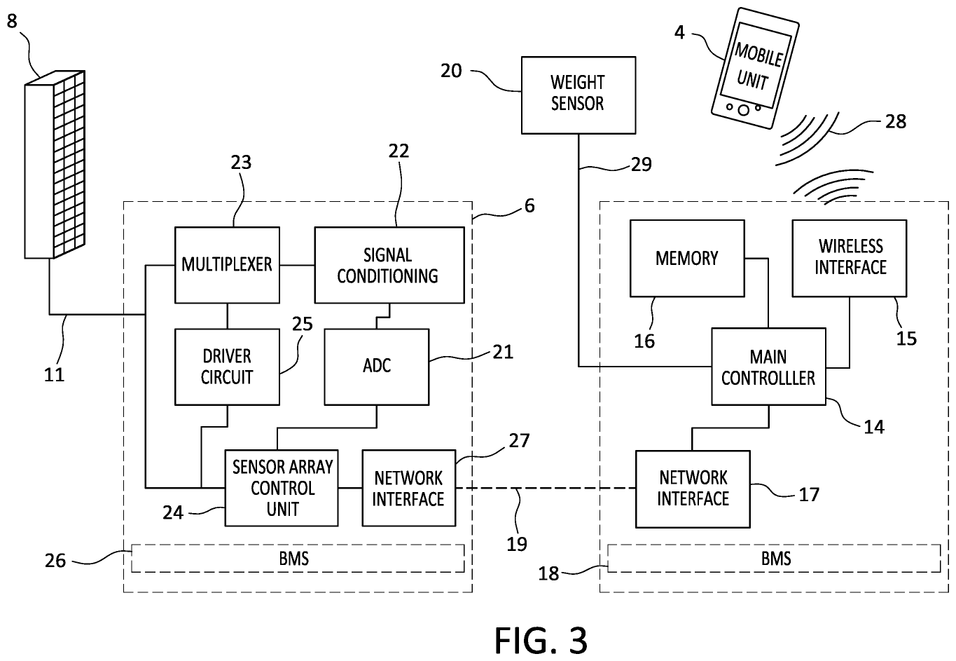

In relation to FIG. 3, said figure shows a detailed block diagram of the control unit 1 and the sensor array controller 6. Thus, the control unit 1 is made up of a main controller 14 in charge of controlling the operation of said unit, a network interface 17 which allows for communication with the sensor array controller 6 through a similar network interface 27 located in said controller, a memory module 16 for storing data, a wireless network interface 15 which allows for communication with the mobile device 4, as will be defined in greater detail below, and a battery management system 18 for supplying electric current to all of the elements of said control unit 1. Thus, the main controller is connected by a wired or wireless connection 29 to the weight sensor 20 located on the weight-measuring platform 3, through which it detects the presence of the user 2 and measures the weight of the same. Once the presence of the user 2 is detected, instructions or control commands are sent by means of the network interface 17 to the network interface 27 of the sensor array controller 6 so as to be able to initiate the display process of the sensors following a predetermined sensor measuring sequence by the main controller 14.

The sensor array controller 6 is in turn made up of a sensor array control unit 24 which controls the operation of the sensors only when a person or user 2 is detected on the weight-measuring platform 3, a network interface 27 which receives the network interface signal 17 of the control unit 1, an analog-to-digital convertor (ADC) 21, a signal conditioning circuit 22, a multiplexed system 23, a driver circuit 25 and a battery management system 26. Once the sensor array control unit 24 has received the order from the network interface 27 to take the measurement of a sensor, the same is ordered to activate the driver circuit 25, and activate the multiplexed system 23 to select the specific sensor element indicated by the control unit 6. The signal received by the specific sensor from the sensor array 8 through a cable that interconnects said sensor array 8 and the sensor array controller 6 is conditioned by the conditioning circuit 22 and then digitalized by the analog-to-digital converter 21 for the subsequent sending of the same. This already digitalized measurement value is newly transmitted though the interface by the sensor array control unit 24 using the network interface 27 to the control unit 1 of the system of the present invention, which receives the data of the measurements through the network interface 17 thereof, and is processed and stored in the memory 16 by the main controller 14. Once the data is processed, they are wirelessly transmitted to the mobile unit or device 4 and to the remote servers (not shown) by wireless communication means 28.

The process is repeated with each one of the sensor elements of the sensor array 8 of the system of the invention. Thus the sensors work together, and for that reason the control unit 1 simultaneously controls two or more sensor array controllers 6, managing the drive of two emitters or sensors of a sensor array 8 and the reception of others in one or several sensor arrays 8.

Both the control unit 1 and the sensor array controller 6 are elements powered by batteries and have a battery management system 18 and 26, respectively, which powers all of the elements of the system. Likewise, the sensor array 8 is also powered by the battery management system 26, just like the elements that form part of the sensor array controller 6 (Elements with the following numbering: 21, 22, 23, 24, 25 and 27, and previously defined). The battery management system 18 powers the elements that form part of the control unit 1 (Elements with the following numbering: 14, 15, 16, 17 and 21, and previously defined).

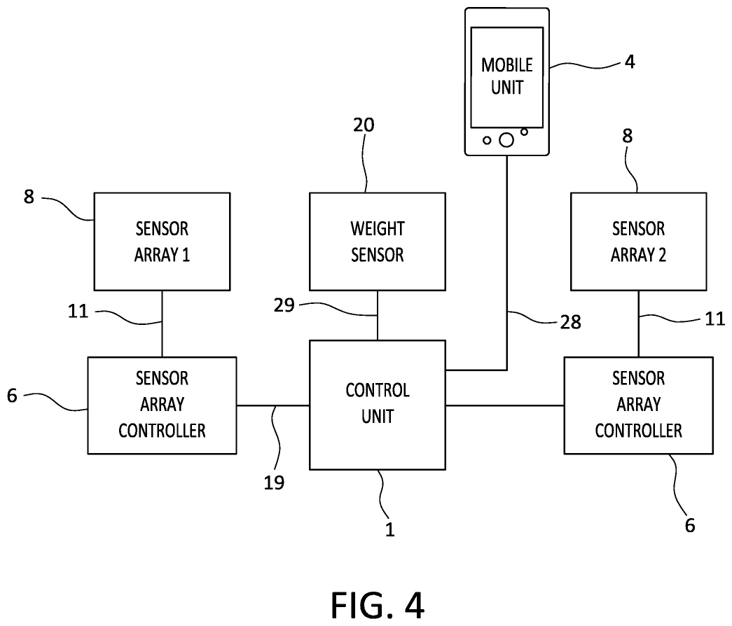

Now, FIG. 4 shows a block diagram of the system object of the present invention and how the elements are interconnected, with the aim of taking the measurements for the estimation of the volume and density of the user's 2 body. Thus, the control unit 1 controls two or more sensor array controllers 6 and is connected to them preferably by means of a cable 19, although, as envisaged within the scope of the invention, said connection can also be wireless. Each sensor array controller 6 is connected to a sensor array 8, and likewise the connection between these units (controller 6 and sensor array 8) is, preferably, but not limited to, by means of a multicore cable 11 through which the array is powered 8 from the controller 6 and the driver signals, and the measurements taken by the sensor elements are transmitted. The weight sensor 20 is connected by means of a cable 29 to the control unit 1, wherein by said cable 29 the weight sensor 20 is powered by the control unit 1, and the weight signal is transmitted from the sensor 20 to the control unit 1.

1. A non-invasive system for estimating the volume and density of a body, wherein the information is duly controlled and viewed by the user, the system comprising:
a control unit that controls the operation of the system and the measurement of the weight of the user;
a weight-measuring platform, on which the user is placed and the activation of the system when said user is on the same;
a mobile unit or device for configuring and viewing the operation of the system and the results of the measurement, directly manipulated by the user;
a main structure, which houses the control unit and the weight-measuring platform;
at least one sensor array made up of a plurality of capacitive sensors and a plurality of optical sensors; and
at least one sensor array controller that controls and acquires the signals of at least a sensor array.

2. The estimation system according to claim 1, wherein the control unit is made up of a main controller, a wireless interface, a memory module, a network interface and a battery system.

3. The estimation system according to claim 1, wherein the main structure is connected to the controllers of the sensor arrays by means of a connection mechanism, such as cables.

4. The estimation system according to claim 1, wherein the sensor array is made up of a series of rectangular electrodes arranged in an array and separated from one another by a space, wherein said rectangular electrodes correspond to capacitive sensors.

5. The estimation system according to claim 4, wherein the space between the electrodes is less than 2 millimeters.

6. The estimation system according to claim 1, wherein the optical sensors are located on each side of the sensor array, wherein each arrangement of optical sensors consists of a row of photoemitters and photoreceptors.

7. The estimation system according to claim 1, wherein the sensor array has a depth that is variable and is in the range of a few millimeters.

8. The estimation system according to claim 2, wherein the main controller is connected by a wired or wireless connection to the weight sensor located on the weight-measuring platform, through which it detects the presence of the user and measures the weight of the same.

9. The estimation system according to claim 1, wherein the sensor array controller is made up of an analog-to-digital converter (ADC), a signal conditioning module, a multiplexer, a sensor array control unit, a driver circuit, a battery system, and a network interface.

10. The estimation system according to claim 1, wherein the control unit simultaneously controls two or more sensor array controllers, managing the drive of two emitters or sensors of a sensor array and the reception of others in one or several sensor arrays.
